(19) United States
(12) Patent Application Publication
(10) Pub. No.: US 2017/0030610 A1
(43) Pub. Date: Feb. 2, 2017

(54) FLOW CHANNEL AND HEATING, VENTILATION, OR AIR CONDITIONING SYSTEM

(71) Applicant: MAHLE International GmbH, Stuttgart (DE)

(72) Inventors: Norman SCHAAKE, Markgroeningen (DE); Lars KIEKE, Stuttgart (DE)

(73) Assignee: MAHLE International GmbH, Stuttgart (DE)

(21) Appl. No.: 15/211,349

(22) Filed: Jul. 15, 2016

(30) Foreign Application Priority Data
Jul. 31, 2015 (DE) 10 2015 214 709.6

(51) Int. Cl. F24F 13/24; B60H 1/00; G10K 11/172; F24F 13/02

(52) U.S. Cl. CPC F24F 13/24; F24F 13/02; B60H 1/00564; G10K 11/172; B60H 2001/006; F24F 2013/245

(57) ABSTRACT

A flow channel, in particular for a heating, ventilation, or air conditioning system, whereby the flow channel has a flow channel inner wall with at least one recess and at least one sound-permeable cover, whereby the at least one sound-permeable cover covers the at least one recess in order to conduct a fluid stream, flowing through the flow channel, away from the at least one recess, and with at least one acoustic dampening chamber, which surrounds the at least one recess on a side, facing away from the flow channel, of the at least one sound-permeable cover, whereby the at least one acoustic dampening chamber has at least one partition wall that divides the at least one acoustic dampening chamber into at least two compartments.

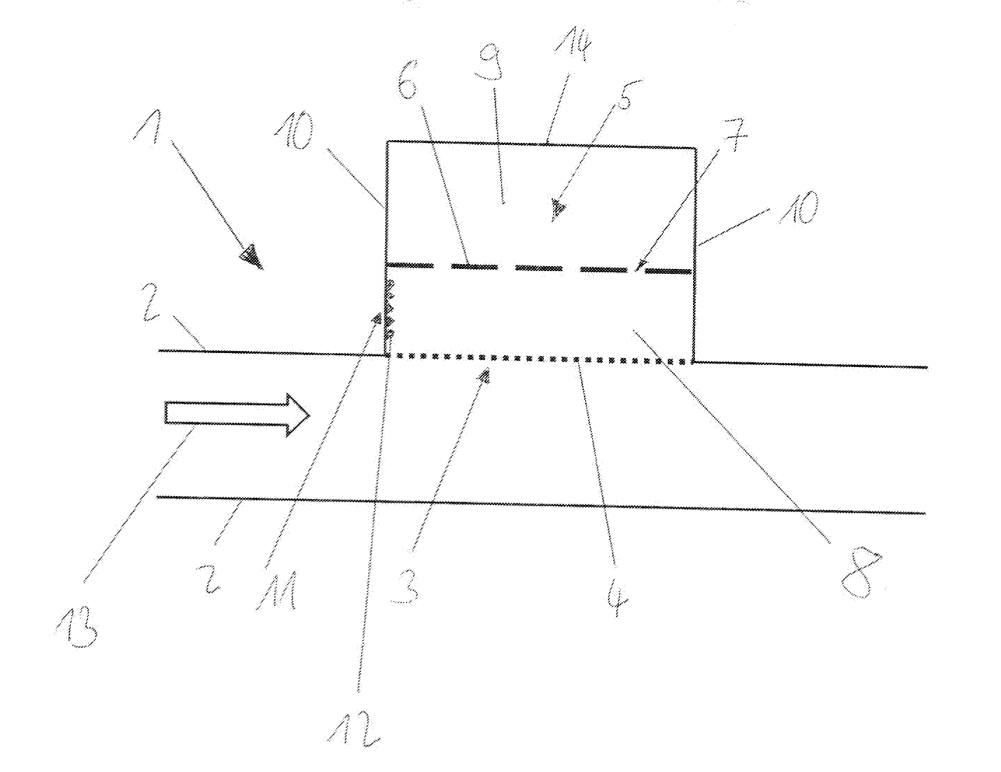

This nonprovisional application claims priority under 35 U.S.C. §119(a) to German Patent Application No. 10 2015 214 709.6, which was filed in Germany on Jul. 31, 2015, and which is herein incorporated by reference.

### BACKGROUND OF THE INVENTION

Field of the Invention

The invention relates to a flow channel according and to a heating, ventilation, or air conditioning system, in particular for a motor vehicle or a building, in which system a flow channel of this kind is disposed.

Description of the Background Art

Heating, ventilation, or air conditioning systems, in particular for motor vehicles or optionally also for buildings, as well as for exhaust systems for motor vehicles with internal combustion engines, have flow channels which convey fluids and in so doing also transmit sound waves and thereby often irritating noises. These can be, for example, noises that arise during the operation of a heating, ventilation, or air conditioning system or of an exhaust system of a motor vehicle and are transmitted via the flow channels into a vehicle interior or the vehicle environment. These can also be noises that are carried beyond adjacent rooms in a building via flow channels of a heating, ventilation, or air conditioning system. There are various approaches to reducing the noise propagation in flow channels.

US 2010/0284789 A1 discloses an acoustic damping assembly for reducing flow-induced noises in devices with gas turbines. The damping assembly has an acoustic insulation layer, which in a sandwich structure has a core, formed as a labyrinth or honeycomb, and two perforated outer layers surrounding the core. The acoustic insulation layer in the damping assembly covers a resonator chamber in whose interior labyrinthine or honeycomb acoustic insulation structures are located.

DE 41 15 171 A1 discloses a fan/filter unit for clean room ceilings with a fan with a fan impeller which has a diagonal structure and a perimeter from which an annular chamber, bounded on two sides by cone surfaces and connected to a pressure chamber lying below, extends outwardly. The pressure chamber in this case is bounded on one side by HEPA filter material.

WO 2010/086719 A1, which corresponds to U.S. Pat. No. 7,934,581, and which discloses an acoustic broadband resonator having a fluid conduit with a conduit inner wall and a conduit outer wall and a first, second, and third chamber. Each chamber is in fluid communication via a flow area with the fluid conduit. The first and second chambers have the same volume. The third chamber, in contrast, has a smaller volume than the first and second chamber. The flow area connecting the first chamber to the fluid conduit is thereby larger than the flow portion connecting the second chamber to the fluid conduit.

The conventional devices, however, need further improvement with respect to their noise-insulating properties.

### SUMMARY OF THE INVENTION

It is therefore an object of the invention to provide a flow channel that has improved sound-dampening properties. In addition, it is an object of the invention to provide a heating, ventilation, or air conditioning system, in particular for a motor vehicle or a building, in which a flow channel of this kind is disposed.

An exemplary embodiment of the invention provides a flow channel, in particular for a heating, ventilation, or air conditioning system, whereby the flow channel has a flow channel inner wall with at least one recess and at least one sound-permeable cover, whereby the at least one sound-permeable cover covers the at least one recess in order to conduct a fluid stream, flowing through the flow channel, away from the at least one recess, and with at least one acoustic dampening chamber, which surrounds the at least one recess on a side, facing away from the flow channel, of the at least one sound-permeable cover. The at least one acoustic dampening chamber in this case has at least one partition wall that divides the at least one acoustic dampening chamber into at least two compartments. This structure enables a considerable sound reduction without, for example, there being a cost for sound-absorbing foam parts or air guiding elements or a change in the flow channel cross section and a resulting pressure loss. The invention offers the possibility, moreover, to dampen selectively especially irritating sound frequency ranges by means of the shape and the size of the acoustic dampening chamber.

In an embodiment of the flow channel, the at least one partition wall can have a number of openings.

In an embodiment of the flow channel, the openings can be formed as holes and/or slits. The propagation of sound waves is suppressed especially reliably thereby.

In an exemplary embodiment of the flow channel, the at least one partition wall can divide the at least one acoustic dampening chamber into a first compartment, facing the flow channel and disposed adjacent to the at least one sound-permeable cover, and into a second compartment, facing away from the flow channel. The propagation of sound waves is suppressed especially reliably thereby.

In an embodiment of the flow channel, the at least one partition wall can be arranged substantially parallel to the at least one sound-permeable cover and connects two side walls, arranged substantially vertically to the at least one sound-permeable cover, of the at least one acoustic dampening chamber. This simplifies the fabrication.

In an exemplary embodiment of the flow channel, the at least one sound-permeable cover can be a nonwoven material. As a result, the cover acquires very good sound-absorbing properties and is nevertheless cost-effective.

In an embodiment of the flow channel, the at least one acoustic dampening chamber can be made as a single piece with the flow channel. This can be realized, for example, inexpensively and without a rather high outlay in structural terms with an injection molding or shaping method.

In an exemplary embodiment of the flow channel, the at least one acoustic dampening chamber can have at least one inner wall region on which surface structures suitable for sound dampening are formed. The surface structures absorb the sound waves penetrating into the acoustic dampening chamber. Sound leakage out of the flow channel, for example, into the interior of a motor vehicle, is reduced thereby.

An embodiment of the flow channel can have two or more than two acoustic dampening chambers, arranged in a fluid flow direction one behind the other and/or substantially opposite to one another and/or offset to one another on the flow channel inner wall, in each case with at least one partition wall and in each case with at least one sound-permeable cover.

In an exemplary embodiment of the flow channel, the at least one acoustic dampening chamber can have two or more than two partition walls. The propagation of unwanted sound waves can be reduced further in this way in a cost-effective manner which is also structurally simple to realize.

In an embodiment of the flow channel, a sound wave frequency range to be dampened can be established by varying the dimensioning of the at least one acoustic dampening chamber and/or by varying the surface structures and/or the number of partition walls and/or the number and/or design and/or size of the openings.

An exemplary embodiment of the flow channel can have a substantially round and/or a substantially rectangular and/or a substantially square cross section.

In an embodiment of the heating, ventilation, or air conditioning system for a motor vehicle or a building, at least one flow channel designed according to the aforementioned description can be disposed in the heating, ventilation, or air conditioning system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, is not limitive of the present invention, and wherein the sole FIGURE shows a schematic view of a flow channel with an acoustic dampening chamber.

### DETAILED DESCRIPTION

The figure shows a schematic view of flow channel 1. A fluid flows through flow channel 1, for example, in a fluid flow direction 13. The fluid can be, for example, air, if flow channel 1 is disposed in a heating, ventilation, or air conditioning system (not shown). The heating, ventilation, or air conditioning system can be disposed, for example, in a motor vehicle, a ship, a submarine, or aircraft. Moreover, the heating, ventilation, or air conditioning system can also be disposed in aboveground or underground buildings and in a production facility or storage facility, for example, a grain silo. In alternative embodiments, flow channel 1 can be part of an exhaust gas unit (not shown), for example, of a motor vehicle or a building. In this case, the fluid is, for example, an exhaust gas or a mixture of exhaust gas and air.

Flow channel 1 has a flow channel inner wall 2. Flow channel inner wall 2 can be formed differently in various embodiments, so that flow channel 1 can have, for example, a round, rectangular, or also square cross section or a cross section with a different structure.

A recess 3 is formed in the area of flow channel inner wall 2. Recess 3 is spanned by a sound-permeable cover 4.

From the perspective of flow channel 1, an acoustic dampening chamber 5 is located behind sound-permeable cover 4. Sound-permeable cover 4 conducts the fluid flow away from recess 3, so that the fluid substantially does not flow through acoustic dampening chamber 5. Sound-permeable cover 4 thereby substantially closes off acoustic dampening chamber 5 for the fluid. In one embodiment, sound-permeable cover 4 is a nonwoven material and has sound-absorbing properties. In alternative exemplary embodiments, sound-permeable cover 4 is not a nonwoven material but a different type of textile fabric. Sound-permeable cover 4 in this case can be made, for example, of mineral, animal, plant, or chemical fibers. Sound-permeable cover 4 and flow channel inner wall 2 form a continuous surface for conducting the fluid flow away from recess 3.

Acoustic dampening chamber 5 has two side walls 10, arranged opposite to one another and vertically to flow channel inner wall 2, and a back wall 14, arranged vertically to side walls 10 and arranged parallel to flow channel inner wall 2. Acoustic dampening chamber 5 by way of example has a rectangular shape here. In alternative embodiments, acoustic dampening chamber 5 can also have a square or round shape. Acoustic dampening chamber 5 can be made as a single piece with flow channel 1 out of aluminum, an aluminum alloy, plastic, or sheet steel.

Acoustic dampening chamber 5 causes a sound reduction in flow channel 1. Sound waves are absorbed by sound-permeable cover 4 and enter acoustic dampening chamber 5. Sound energy is removed from the sound wave continuing to move in flow channel 1 and is converted to heat. Depending on the geometric design of recess 3 and acoustic dampening chamber 5, the frequency range of the sound wave is reduced particularly in terms of broadband. Moreover, the acoustic absorption can be varied by the material and thickness of sound-permeable cover 4.

Side walls 10 and back wall 14 of acoustic dampening chamber 5 can have one or more than one inner wall region 11 with surface structures 12. Surface structures 12 are formed such that they absorb sound waves to a particular degree and thereby contribute to additional sound reduction by converting sound wave energy into heat due to friction. In this case, surface structures 12 can be, for example, irregularly arranged pointed projections, made of sound-absorbing material and projecting from an inner wall 11 into acoustic dampening chamber 5. The extensiveness of one or more than one inner wall region 11 can vary.

A partition wall 6 is located in acoustic dampening chamber 5. Partition wall 6 is arranged, for example, parallel to back wall 14 and parallel to sound-permeable cover 4 and connects the two side walls 10 to one another. Partition wall 6 is made, for example, of aluminum, an aluminum alloy, plastic, or sheet steel.

Partition wall 6 is arranged approximately in the middle in regard to side walls 10. In so doing, it divides acoustic dampening chamber 5 into a first compartment 8, located between partition wall 6 and sound-permeable cover 4, and a second compartment 9, located between partition wall 6 and back wall 14.

Partition wall 6 has a number of openings 7. Openings 7 can be formed, by way of example, as slits or holes. Partition wall 6 can be made, for example, of aluminum, an aluminum alloy, plastic, or sheet steel, in which openings 7 are stamped in, for example. The shape, size, and number of openings 7 can vary in different exemplary embodiments. Moreover, two or more than two partition walls 6 can be arranged in acoustic dampening chamber 5. The way in which one or more than one partition wall 6 are arranged in acoustic dampening chamber 5 can vary.

The at least one partition wall 6 produces additional sound absorption, because sound waves reflected in particular by back wall 14 are absorbed by partition wall 6 and the edge regions of openings 7.

In different exemplary embodiments, a plurality of acoustic dampening chambers 5 are disposed in the area of flow channel 1. These can be arranged in fluid flow direction 13 one behind the other, opposite to one another, or offset to one another on the perimeter of flow channel 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A flow channel for a heating, ventilation, or air conditioning system, the flow channel comprising:
a flow channel inner wall with at least one recess and at least one sound-permeable cover, the at least one sound-permeable cover covering the at least one recess in order to conduct a fluid stream flowing through the flow channel away from the at least one recess; and
at least one acoustic dampening chamber that surrounds the at least one recess on a side, facing away from the flow channel, of the at least one sound-permeable cover, the at least one acoustic dampening chamber having at least one partition wall that divides the at least one acoustic dampening chamber into at least two compartments.

2. The flow channel according to claim 1, wherein the at least one partition wall has a purality of openings.

3. The flow channel according to claim 2, wherein the openings are formed as holes and/or slits.

4. The flow channel according to claim 1, wherein the at least one partition wall substantially divides the at least one acoustic dampening chamber into a first compartment facing the flow channel and disposed adjacent to the at least one sound-permeable cover and into a second compartment facing away from the flow channel.

5. The flow channel according to claim 1, wherein the at least one partition wall is arranged substantially parallel to the at least one sound-permeable cover and connects two side walls, arranged substantially vertically to the at least one sound-permeable cover, of the at least one acoustic dampening chamber to one another.

6. The flow channel according to claim 1, wherein the at least one sound-permeable cover is a nonwoven material.

7. The flow channel according to claim 1, wherein the at least one acoustic dampening chamber is made as a single piece with the flow channel.

8. The flow channel according to claim 1, wherein the at least one acoustic dampening chamber has at least one inner wall region, on which surface structures suitable for sound dampening are formed.

9. The flow channel according to claim 1, wherein the flow channel has two or more than two acoustic dampening chambers arranged in a fluid flow direction one behind the other and/or substantially opposite to one another and/or offset to one another on the flow channel inner wall, with at least one partition wall and with at least one sound-permeable cover.

10. The flow channel according to claim 1, wherein the at least one acoustic dampening chamber has two or more than two partition walls.

11. The flow channel according to claim 1, wherein a sound wave frequency range to be dampened can be established by varying the dimensioning of the at least one acoustic dampening chamber and/or by varying the surface structures and/or the number of partition walls and/or the number and/or design of the openings.

12. The flow channel according to claim 1, wherein the flow channel has a substantially round and/or a substantially rectangular and/or a substantially square cross section.

13. A heating, ventilation, or air conditioning system for a motor vehicle or a building, wherein at least one flow channel according to claim 1 is disposed in the heating, heating, or air conditioning system.
